(19) United States
(12) Patent Application Publication
(10) Pub. No.: US 2007/0294095 A1
(43) Pub. Date: Dec. 20, 2007

(54) Method of connecting people for social interaction

(76) Inventor: David B. Schaum, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 11/471,222

(22) Filed: Jun. 19, 2006

(51) Int. Cl. G06Q 10/00; G06Q 30/00

(52) U.S. Cl. 705/1

(57) ABSTRACT

A method of connecting two individuals for social interaction on the Internet uses a sign attached to a window of a vehicle occupied by one of the individuals. When the vehicle occupant sees another person, either a pedestrian or in another vehicle, the vehicle occupant illuminates the sign to direct a message at the other individual. The message contains the vehicle occupant's e-mail address or screen name with an invitation to communicate on-line via a computer network such as the Internet.

### BACKGROUND OF THE INVENTION

1. Field of the Invention

The present invention is directed to a method of inviting communication, and more particularly, to a method for directing a targeted message to another individual using a sign and inviting the person to engage in subsequent communication on-line via a computer network.

2. Discussion of the Related Art

Meeting new people to begin a relationship can be a stressful and sometimes awkward undertaking, which all too often ends in disappointment. Many times, people will see someone they find attractive at a social gathering and, while they hope to get to know the person, they might be somewhat reluctant to approach the other person to begin a conversation. More commonly, a person will see someone they find attractive while they are driving in their car. They might smile at the other person as a gesture of affection, when given an opportunity, for instance while stopped at a traffic light. And, while the other person may return the smile, when the traffic light turns green the two will most likely drive away never to meet again.

The Internet has presented a whole new opportunity for people to socialize without the pressures of face-to-face introductions. It is becoming quite common for two individuals to initially “meet” on the Internet in a chat room or other social forums. Use of a computer to communicate enables each person to express their thoughts without the pressures of public introduction where people are generally more nervous and find it difficult to express their thoughts and feelings to the other person. However, when an initial meeting of two people takes place on the Internet, they each begin to create an image of the other person in their mind, without having actually seen the other person. If the two eventually arrange to meet or exchange photos, typically the appearance of the other person is far different from the image created in one's mind. And, while each person may initially try to hide their feelings of disappointment, in many cases they quickly break off the relationship.

In view of the foregoing problems associated with meeting new people to begin a relationship, there remains a need for a convenient and less awkward method for enabling two people to become acquainted with each other. More particularly, there remains a need to enable a person to conveniently invite another person to communicate on-line, via a computer network such as the Internet, so as to avoid the pressure and awkwardness of a face-to-face introduction.

### BRIEF DESCRIPTION OF THE DRAWINGS

For a fuller understanding of the nature of the present invention, reference should be made to the following detailed description taken in conjunction with the accompanying drawings in which:

FIG. 1 is an elevational view showing a sign mounted to a window of a vehicle for directing a message containing the vehicle occupant's e-mail address or screen name at another person in accordance with the method of the present invention;

FIG. 2 is a side elevation, in cross section, showing a sign for displaying a message in accordance with the present invention; and

FIG. 3 is a circuit diagram of the sign of FIG. 2.

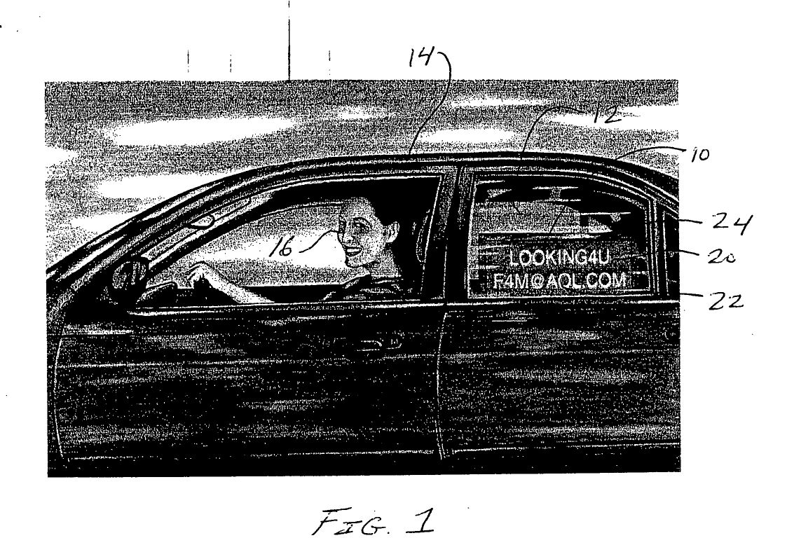

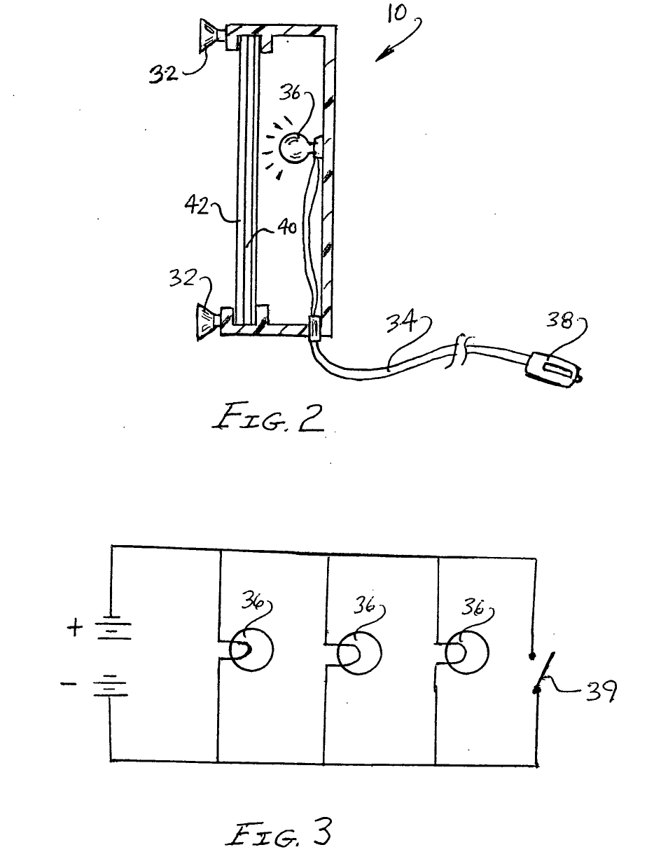

Like reference numerals refer to like parts throughout the several views of the drawings.

### DETAILED DESCRIPTION OF THE PREFERRED EMBODIMENTS

A method of connecting two individuals for social interaction on the Internet uses a sign 10 attached to a window 12 of a vehicle 14 occupied by one of the individuals 16. When the vehicle occupant 16 sees another person, either a pedestrian or in another vehicle, the vehicle occupant 16 illuminates the sign 10 to direct a message 20 at the other individual. The message 20 contains the vehicle occupant's e-mail address or screen name 22 with an invitation 24 to communicate on-line via a computer network such as the Internet. The sign 10 is powered by either the vehicle's electric power supply system (i.e., alternator and battery) or by a battery power source stored in the sign. The vehicle occupant 16 activates the sign to illuminate the message, by either plugging a cord into the vehicle's cigarette lighter, a 12 volt connection, or with the use of a switch located within reach of the driver of the vehicle.

In a preferred embodiment, the sign 10 is provided in the form of a portable box unit 30 which attaches to the vehicle window 12 with the use of suction cups 32. A cord 34 for powering a light source 36 within the box extends to a plug 38 for connection with the vehicle's cigarette lighter to thereby provide power to the light source. Alternately, a switch 39 may be installed within easy reach of the vehicle occupant for controlling activation of the light source 36 and illumination of the message on the sign. A first panel 40 contains the message 20 and is customized for each particular user. Specifically, the first panel 40 includes the message 20 with the user's e-mail address or screen name 22 and an appropriate invitation 24. A second translucent panel 42 overlies the first panel 40 so that the message on the first panel is not visible when the sign is not illuminated (i.e., when the light source is not activated). In this manner, the message on the sign is not viewable by the general public when the sign is not illuminated. This allows the user (i.e., vehicle occupant) 16 to direct the message to a targeted individual so that the particular targeted individual will realize that the message is being directed to their attention. In the event the person receiving the message decides that he/she is not attracted to the vehicle occupant 16, or just does not want to engage in any communication with the vehicle occupant, then that person can simply ignore the message and avoid making subsequent on-line contact with the vehicle occupant 16. On the other hand, if the recipient of the message decides that they may want to explore the possibility of a relationship with the vehicle occupant 16, then they can safely contact the vehicle occupant 16 on-line, at the vehicle occupant's e-mail address or screen name. This allows both individuals to get to know each other by electronic communication, via the Internet, prior to proceeding any further with a personal relationship.

While the instant invention has been shown and described in accordance with a practical and preferred embodiment thereof, it is recognized that departures from the instant disclosure are contemplated within the spirit and scope of the invention, which should not be limited except as defined in the following claims.

What is claimed is:

1. A method for establishing social interaction on a computer network comprising the steps of:
providing a device to a first person, wherein said device includes means operable by the first person for selectively displaying a message containing information identifying how to contact the first person on the computer network;
providing means for allowing the first person to selectively operate the device to direct said message to the attention of a second person selected by the first person;
allowing the second person to see the first person and obtain the information; and
allowing the second person to selectively contact the first person via the computer network to establish electronic communication between the first person and the second person.

2. The method as recited in claim 1 further comprising the step of:
carrying said device in an automobile so that said message is viewable from an exterior of the automobile through the windows of the automobile.

3. The method as recited in claim 2 further comprising the step of:
displaying a message containing the first person's e-mail address.

4. The method as recited in claim 3 wherein said step of displaying further includes the step of:
requesting the second person to contact the first person at the displayed e-mail address.

5. A method for establishing social interaction on a computer network comprising the steps of:
carrying a device in an automobile, wherein said device includes display means for displaying a message, and further wherein said display means is operable between an on condition to make said message viewable and an off condition so that said message is not viewable;
gaining the attention of a person exterior of the automobile;
activating said display means to said on condition so that said message is viewable to the person exterior of the automobile;
displaying information in said message inviting the person exterior of the automobile to contact an occupant of the automobile on the computer network;
displaying information explaining how to contact the occupant of the automobile on the computer network; and
allowing the person exterior of the automobile to selectively contact the occupant of the automobile via the computer network to establish electronic communication between the occupant of the automobile and the person exterior of the automobile.
